(19) United States
(12) Patent Application Publication
(10) Pub. No.: US 2003/0131052 A1
(43) Pub. Date: Jul. 10, 2003

(54) Method and system for HTTP time-on-page monitoring without client-side installation

(75) Inventor: Ronald C. Allan, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATIOIN, ARMONK, NY (US)

(21) Appl. No.: 10/045,282

(22) Filed: Jan. 10, 2002

(51) Int. Cl. G06F 15/16

(52) U.S. Cl. 709/203; 709/224

(57) ABSTRACT

A method, system, apparatus, and computer program product are presented for collecting time-on-page statistics. When a server receives a request for a Web page, the server generates or retrieves the Web page and then instruments the Web page to collect time-on-page metrics by inserting a script into the Web page, after which the Web page is returned to the requesting client. The browser processes the Web page and interprets the embedded script; the script defines a function that is evaluated when the browser determines to load a different Web page. The browser then presents the Web page, but when the Web page is unloaded, the function is invoked; the function computes a time value that represents the amount of time that the browser has presented the Web page. The function then returns to the server the computed time value as a time-on-page metric value.

### BACKGROUND OF THE INVENTION

1. Field of the Invention

The present invention relates to an improved data processing system and, in particular, to a method and apparatus for retrieving operational data from a client system in a network.

2. Description of Related Art

Distribution of information across the Internet has continued to increase dramatically, and World Wide Web-based and Internet-based applications are so common that one assumes that all individuals have access to Internet services. Many commercially available word processing programs can output documents that are formatted with various types of markup languages, and these documents can be immediately published onto the Web so that they are available to anyone with a browser.

Most publishers, whether an individual or an organization, generally desire to reach the broadest audience for whatever content or information that they publish on the Web. However, some Web sites are designed for a particular audience. In some cases, optimizing a Web site for a particular audience may entail costly and time-consuming modifications, but these efforts may be minimal compared to the potential sales that may be achieved by having a more useful Web site.

E-businesses, Web-content publishers, Web-site operators, and advertisers gather metrics on the manner in which users peruse Web sites, and various categories have been devised to interpret the collected data. For example, the term “page hits” refers to the number of Web pages that a Web site has served, while the term “click-throughs” refers to the number of users who have clicked on, or otherwise selected to view, an advertisement on a Web page. In general, higher values for these metrics are more desirable because they reflect that users are responding positively to what is being presented to them. More importantly, advertising revenues are often calculated using formulas with these metrics as inputs, thereby benefiting e-businesses when these metrics increase. By correlating improvements to the Web pages available on a Web site with increased Web-site traffic, e-businesses are able to judge the cost-effectiveness of certain content, layout, or functional features on the Web site.

Many of these metrics are server-side metrics, i.e. they can be gathered through operations at a Web site's server. However, some client-side metrics exist, i.e. information that can only be gathered at the client. One client-side metric is the amount of time that a user has viewed a particular Web page, which is usually termed the “time-on-page” metric. In general, it would be more desirable for a particular Web site if users spend long periods of time viewing its Web pages because the Web site owner or operator typically has more opportunity to sell products or show advertisements.

Given the client-server nature of the World Wide Web in which most Web content is served in a stateless manner to browser applications, it is usually not possible for the server to know when the user has finished looking at a particular Web page and has started perusing a different Web site. By installing a client-side agent, which might be in the form of client-side proxy or browser plug-in, time-on-page metric data could be collected and periodically forwarded to a third-party service, which statistically processes the data from many users for the benefit of the service's customers, such as advertisers or Web-site operators.

While it may be possible to install client-side agents on the computers within an organization, not many public users would allow the installation of such agents on their client devices even when given some type of incentive because of privacy concerns. It would also be difficult to ensure that the client devices that had such agents corresponded to the users that visited a particular Web site in order for particular Web-site operators to receive the time-on-page information that they desire. In other words, it would be difficult to ensure that the time-on-page metric data was statistically meaningful.

Therefore, it would be advantageous to have a technique for gathering time-on-page metric data in a manner that foregoes the installation of a client-side agent. It would be particularly advantageous if time-on-page metrics could be collected without modification to standard markup language specifications nor Internet-related protocols.

### SUMMARY OF THE INVENTION

A method, system, apparatus, and computer program product are presented for collecting time-on-page statistics. When a server receives a request for a Web page, the server generates or retrieves the Web page and then instruments the Web page to collect time-on-page metrics by inserting a script into the Web page, after which the Web page is returned to the requesting client. The browser processes the Web page and interprets the embedded script; the script defines a function that is evaluated when the browser determines to load a different Web page. The browser then presents the Web page, but when the Web page is unloaded, the function is invoked; the function computes a time value that represents the amount of time that the browser has presented the Web page. The function then returns to the server the computed time value as a time-on-page metric value.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 is a block diagram that depicts a client-server system including a server-side configuration of components for implementing the present invention;

FIG. 3 is a flowchart that depicts a server-side process for instrumenting a server response datastream;

FIG. 4 is a flowchart that depicts a client-side process for generating time-on-page metric data in accordance with the present invention;

FIG. 5 is a flowchart that depicts a server-side process for receiving time-on-page metric data in accordance with the present invention; and

FIG. 6 is an example of a simple Web page that contains a script which collects a time-on-page metric value and then returns the metric value to a server.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

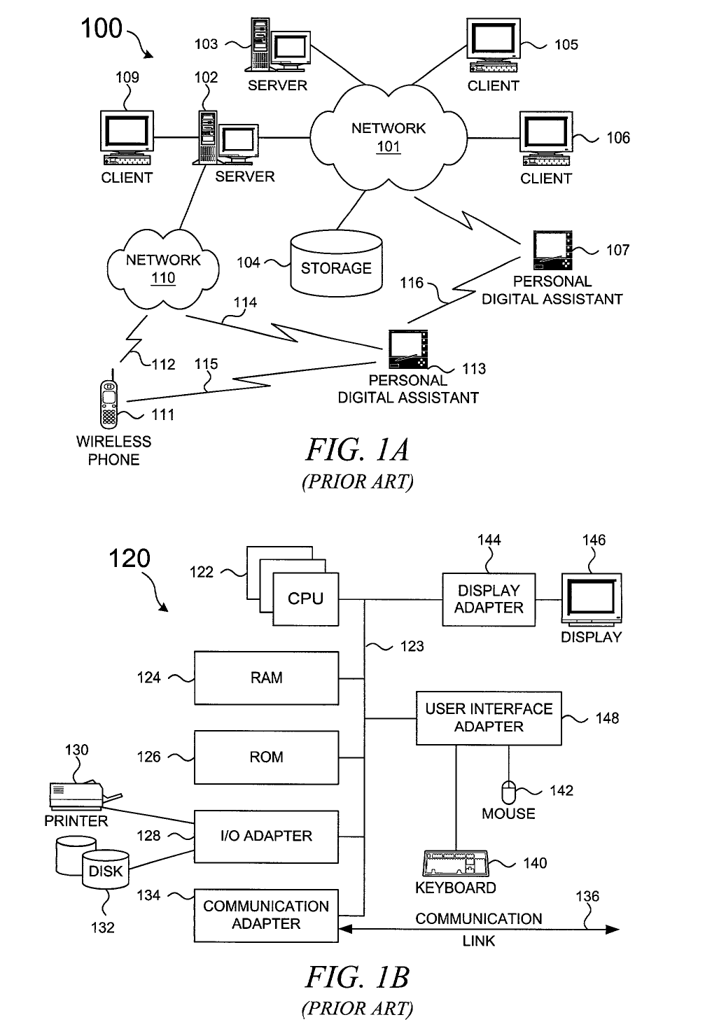

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. Hence, it should be noted that the distributed data processing system shown in FIG. 1A is contemplated as being fully able to support a variety of peer-to-peer subnets and peer-to-peer services.

The present invention may be implemented on a variety of hardware and software platforms, as described above. More specifically, though, the present invention is directed to technique for collecting time-on-page metric data from a client device and then returning the metric data to a server. To accomplish this goal, an HTTP server response datastream containing a Web page is instrumented with a function that collects and returns the metric data. The technique is described in more detail with respect to the remaining figures.

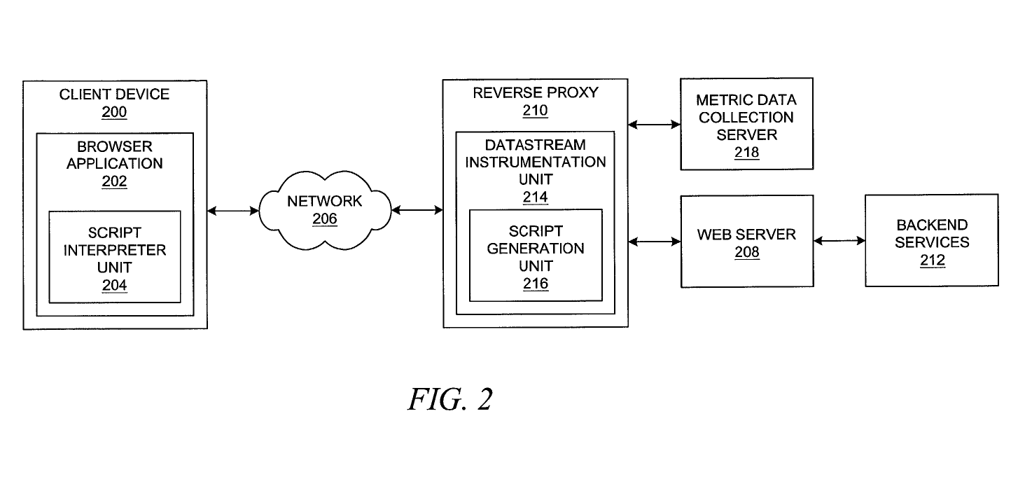

With reference now to FIG. 2, a block diagram depicts a client-server system including a server-side configuration of components for implementing the present invention. Client device 200 supports browser application 202 that includes script interpreter unit 204. A browser application typically comprises a network communication component for sending and receiving requests and responses to/from a server, e.g., HTTP data packets. A graphical user interface (GUI) component displays application controls for the browser application and presents data within one or more content areas, e.g., frames, of the one or more windows of the browser application. The browser application may contain a virtual machine, such as a Java® virtual machine (JVM), which interprets specially formed bytecodes for executing applications or applets within a secure environment under the control of the virtual machine.

A browser application contains a markup language interpreter for parsing and retrieving information within markup-language-formatted files. Typically, when a user of a client device is viewing information from a Web site, the browser application receives documents that are structured in accordance with a standard markup language; a markup language document contains tags that inform the browser application of the type of content within the document, what actions should be taken with respect to other documents referenced by the current document, how the entities within the document should be displayed or otherwise presented to a user, etc. For example, most Web pages are formatted with HTML tags.

The browser application also typically contains a script interpreter for parsing and interpreting one or more script languages that may be supported by the browser application. According to the Microsoft® Press Computer Dictionary, Third Edition, a scripting language is “a simple programming language designed to perform special or limited tasks, sometimes associated with a particular application or function.” For example, most browsers contain support for the JavaScript® language, which is a cross-platform, object-based scripting language that was originally developed for use by the Netscape® Navigator browser. Scripting languages cannot be used to write stand-alone applications as they lack certain capabilities. Moreover, scripting languages can run only in the presence of an interpreter.

When a user makes a request to view a Web page within a browser, e.g., by clicking on a hyperlink within another Web page, the user's client eventually sends a request for the Web page to a server by identifying the Uniform Resource Locator (URL) of the Web page, which returns a document comprising the Web page as a response to the client. More general content that is identifiable by Uniform Resource Identifiers (URIs), a superset of standard identifiers that includes URLs, may also be requested. Returned documents usually contain content that has been formatted with HTML tags, and some of the content may comprise embedded JavaScript® statements. The client-side browser processes the HTML document and interprets the JavaScript® statements, which may initiate operations upon entities within the HTML document and/or objects within the browser environment. The resultant data is then presented to the user in some fashion on the client machine.

Microsoft® JScript™ is a scripting language similar to JavaScript® for use within Microsoft® Internet Explorer. To establish a standard scripting language, the European Computer Manufacturing Association (ECMA) has promulgated the ECMAScript Language Specification, also known as ECMA-262, which is similar to both JavaScript® and JScript™. While there may be incompatibilities between the scripting languages, it may be assumed that future versions of JavaScript® and JScript™ will be compatible with the ECMAScript specification.

The characteristics of a scripting language are herein reiterated according to the ECMA-262 specification:

A scripting language is a programming language that is used to manipulate, customize, and automate the facilities of an existing system. In such systems, useful functionality is already available through a user interface, and the scripting language is a mechanism for exposing that functionality to program control. In this way, the existing system is said to provide host environment of objects and facilities which completes the capabilities of the scripting language. . . . A web browser provides an ECMAScript host environment for client-side computation including, for instance, objects that represent windows, menu, pop-ups, dialog boxes, test areas, anchors, frames, history, cookies, and input/output. Further, the host environment provides a means to attach scripting code to events such as change of focus, page and image loading, unloading, error, abort, selection, form submission, and mouse actions. Scripting code appears within the HTML and the displayed page is a combination of user interface elements and fixed and computed text and images. The scripting code is reactive to user interaction and there is no need for a main program.

In general, the scripting languages that are supported by browser applications include a set of event handlers. Certain events are detected by a browser application and then “advertised” or “published” by the browser application such that an event handler can be notified of the event and then perform certain actions. In addition, these scripting languages allow functions to be defined within a given script, and these functions can be associated with an event handler; these functions can have many different purposes. When the event handler is triggered or fired by the occurrence of its particular type of event, the event handler will invoke the function that was previously associated with the event handler.

In brief, using the built-in capabilities of a typical browser, including its script interpreter functions, the present invention invokes client-side functionality to collect client-side metric data in accordance with a script that has been embedded in a Web page that was requested by the user of the client device; the present invention is compatible with a variety of client-side interpretable scripting languages, some of which are mentioned above. More specifically, the present invention associates a function with an event handler that is invoked when the browser fetches a new page to be displayed; the function that is associated with the event handler computes the time-on-page metric value, as is discussed in more detail further below.

Referring again to FIG. 2, request messages, such as HTTP Request messages, from browser application 202 are sent through network 206 toward Web server 208.

In this example, the requests and responses are intercepted and/or processed by reverse proxy 210 for various reasons, such as load balancing, limiting the types of operations that are performed on the Web server, etc.; alternatively, all of the server-side functionality could be located on a single server device. Reverse proxy forwards requests to Web server 208, which may employ backend services 212 to access various applications, such as database management applications. Datastream instrumentation unit 214, determines whether the response message should be instrumented with an embedded script that is created by script generation unit 216. When the reverse proxy receives time-on-page metric data from a client, as explained in more detail below, the data is forwarded to metric collection unit 218 for storage and/or processing.

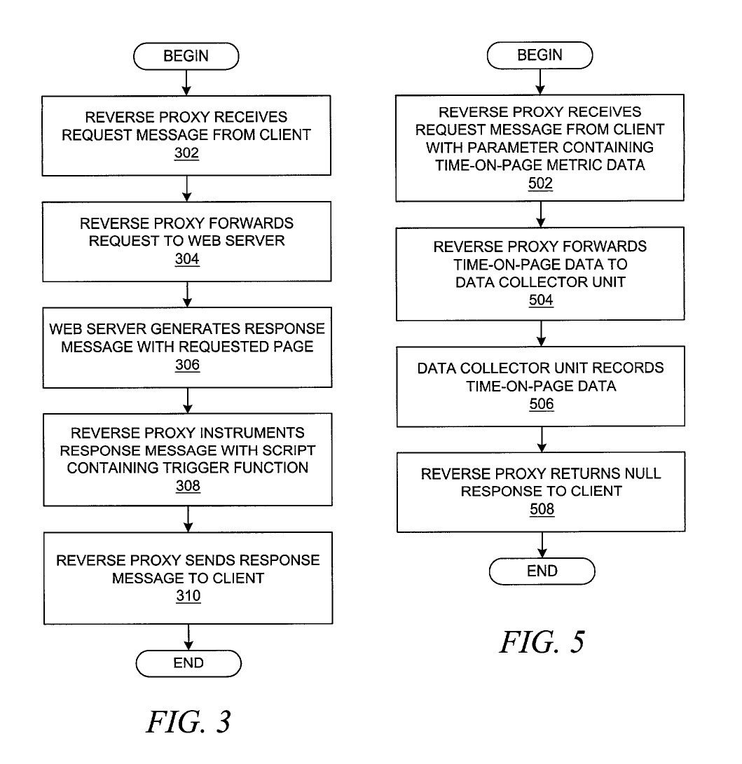

With reference now to FIG. 3, a flowchart depicts a server-side process for instrumenting a server response datastream. The process begins by receiving a request message from a client (step 302), which is then forwarded to the Web server (step 304). The Web server generates a response message, such as an HTTP Response message, that contains the requested Web page in the body of the response message (step 306).

Assuming that a reverse proxy at the server domain is acting as an intermediary agent on the data traffic to and from the server domain, the outgoing server response datastream can be efficiently scanned for HTTP Response messages that carry particular types of content payload in which a time-on-page script could be embedded. In particular, most response messages from the Web server would contain a MIME-type (Multipurpose Internet Mail Extension) identifier that indicates that the message payload is an HTML document. A datastream instrumentation unit that is collocated with the reverse proxy may determine that time-on-page metric data should be collected for the Web page in the response message; if so, an appropriate script containing a trigger function, which is explained in more detail below, is then embedded into the Web page in the response message (step 308). It should be noted that the script may vary with the type of browser application at the client, e.g., Netscape® Navigator or Microsoft® Internet Explorer, which can be determined from the request message because it indicates the originating browser type. The response message is then returned to the client (step 310), and the process is complete.

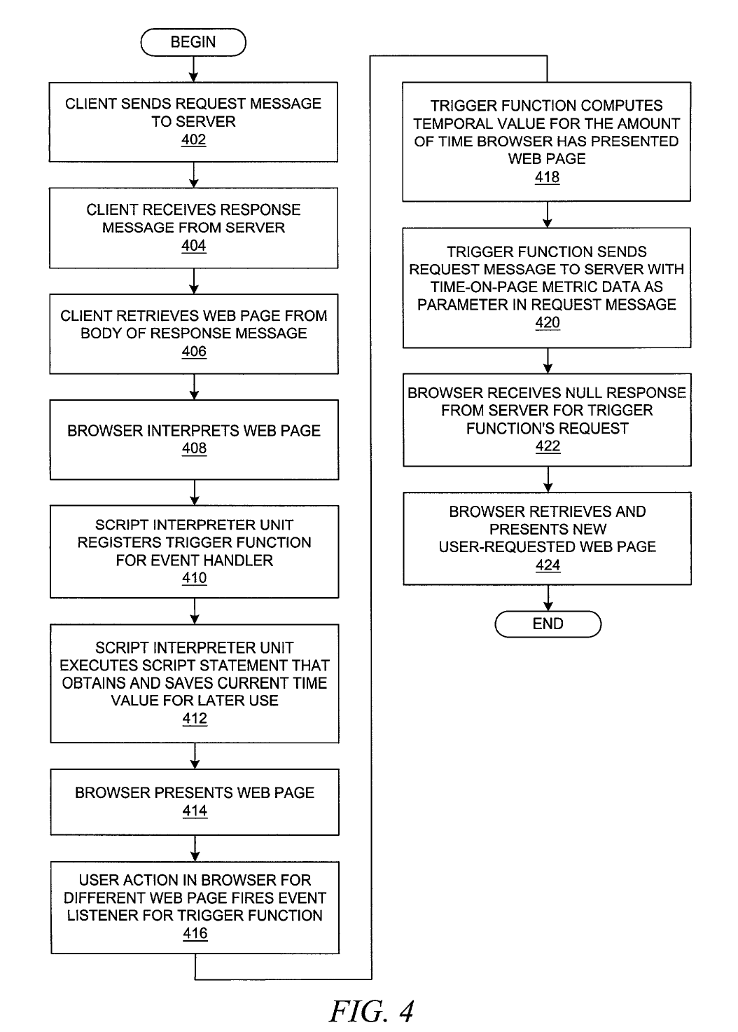

With reference now to FIG. 4, a flowchart depicts a client-side process for generating time-on-page metric data in accordance with the present invention. The process begins with the client device sending a request message to a server for a particular Web page (step 402), which is received in a response message from the server at some later point in time (step 404). The browser then retrieves the web page from the body of the response message (step 406) and interprets the Web page (step 408), during which it discovers the embedded script.

The embedded script contains a trigger function which will be invoked when the user determines to move from the current Web page to a different Web page. The trigger function contains the ability to compute the time-on-page metric data as a difference between a current time value and a time value that was recorded when the Web page was first interpreted, i.e. during step 408.

The event that is generated when the user attempts to change Web pages is “advertised” or “published” by the browser application such that an event handler that is predefined by the scripting language can be notified of the event and then perform certain actions. The JavaScript® scripting language provides an event handler for this event called “onUnload”; when triggered or fired by the browser application's “unloading” of the currently displayed Web page, the “onUnload” event handler will invoke a function that was previously associated with the event handler.

In the present invention, the trigger function that is embedded in the script in the Web page is associated with the “onUnload” event handler or its equivalent. Hence, while interpreting the script, the trigger function is registered with the appropriate event handler that processes the event associated with the change in Web pages by the browser (step 410). In addition, the script contains a statement that retrieves and saves the current time on the client device for subsequent use in computing the time-on-page metric value (step 412).

The browser then presents the requested Web page (step 414). At some subsequent point in time, the user performs an action in an attempt to direct the browser to a new Web page (step 416), which is detected by the browser application, thereby causing the appropriate event handler to be invoked. The trigger function that was previously associated with the event handler is also invoked. Using the previously saved time value, the trigger function gets the current time and computes a difference between the two time values that represents the amount of time that the browser has displayed the current Web page (step 418), i.e. the time-on-page metric value.

The trigger function then sends the time-on-page metric value to a server (step 420), which is preferably the original server that provided the current Web page, although the metric value could be sent to a third-party server that collects the metric values on behalf of the server that served the current Web page. Although the time-on-page could be sent to the server in a variety of ways, it is preferably sent as a parameter in a request message for a “dummy” Web page. As a result, the browser application receives a null response for the trigger function's request (step 422). The browser application can then retrieve and present the new Web page that was requested by the user (step 424), and the process is complete.

With reference now to FIG. 5, a flowchart depicts a server-side process for receiving time-on-page metric data in accordance with the present invention. Assuming that the server system has a reverse proxy configured to process incoming requests, the process begins with the reverse proxy receiving the request for the “dummy” Web page with the attached parameter that represents a time-on-page metric value (step 502), which is recognized by the reverse proxy as a “dummy” Web page request based on the URL in the request message. The reverse proxy forwards the time-on-page metric value to a data collector unit (step 504), which saves the time-on-page metric value (step 506) for statistical or other form of processing. Rather than burden the Web server with the incoming request, the reverse proxy is able to quickly respond with a null response to the client (step 508), thereby completing the process. Assuming that the request messages and response messages are formatted in accordance with the HTTP protocol, the reverse proxy would return a so-called HTTP “204” response code that indicates to the browser application that it should not parse the response for content, i.e. the response message is a “no content” response.

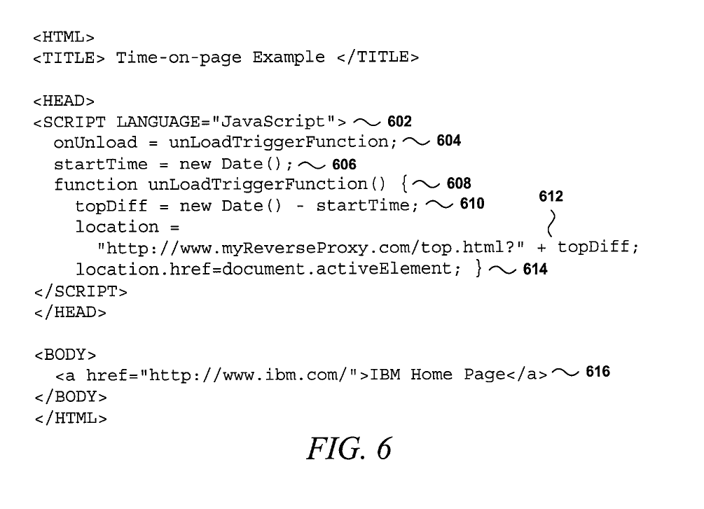

With reference now to FIG. 6, a simple Web page is shown that contains a script which collects a time-on-page metric value and then returns the metric value to a server. It should be noted that the Web page that is shown is for exemplary purposes only, and the tags and statements within the Web page could be adjusted for a particular browser application or for a particular scripting language.

Tag 602 defines a script that is embedded within the Web page and identifies which scripting language is being used. Script statement 604 registers the time-on-page computation function with the “onUnload” event handler. Statement 606 obtains and saves the current time, which is executed when the browser interprets the Web page after it is received from the server and just prior to displaying the Web page. Statement 608 starts the definition of the trigger function, which is executed when the “onUnload” event handler is triggered. Statement 610 computes the time-on-page metric value as the difference between the current time and the time that the Web page was first displayed.

Statement 612 formulates a URL with the time-on-page metric value as a parameter within the URL; this URL would point to a “dummy” Web page which is not returned to the client. Statement 614 sets the focus of the browser to the “dummy” Web page, causing the browser to generate a request message for the Web page; the manner in which the browser application attempts to set location object would vary with the particular functionality available in the browser application. For example, in Microsoft® Internet Explorer, the “location-object” represents the address of the loaded HTML-document such that “location.href” is equal to the address; assigning a value to “location.href” causes the browser to attempt to load the Web page, which generates an HTTP Request message for the Web page. Other browser applications may employ a different document object model that would require a different scripting language statement to achieve equivalent functionality.

Tag 616 causes the browser to display a hyperlink. When the hyperlink is selected by the user, the browser detects that a new page is being requested by the user, i.e. the user is unloading the current Web page and is attempting to load a new Web page. The browser then invokes the “onUnload” event handler, which calls the trigger function that was previously associated with the event handler. The trigger function computes the time-on-page metric value and sends it to the server, which responds with a “no content” Web page that can be ignored by the client's browser application.

The advantages of the present invention should be apparent in view of the detailed description that is provided above. The present invention is able to instrument a Web page with a client-side interpretable script that measures the amount of time that the client's browser application has displayed the Web page, which is also expected to be the amount of time that a user at the client has actually viewed the Web page. The present invention recognizes that existing functionality within the client's browser environment provides the ability to obtain such metric information. Hence, the time-on-page metric value is measured in a lightweight manner without installing a client-side software agent or application.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A data processing method comprising:
generating a Web page at a server;
generating a script, wherein the script comprises a function that returns to the server time-on-page metric data corresponding to an amount of time that the Web page is presented by the client; and
inserting the script into the Web page.

2. The method of claim 1 further comprising:
receiving from a client a request message for the Web page;
generating a response message, wherein the response message comprises a message body with the Web page;
sending the response message to the client.

3. The method of claim 1 wherein a proxy server between the client and the server performs the inserting step.

4. The method of claim 1 wherein the function is evaluated when a browser application at the client determines to present a different Web page other than the Web page in which the script was inserted.

5. The method of claim 4 wherein the function is registered with an event handler that is invoked when the browser application performs a page unload operation.

6. A data processing method comprising:
sending from a client to a server a request message for a Web page;
receiving a response message, wherein the response message comprises a message body with the Web page;
interpreting the Web page, wherein the Web page has an embedded script comprising a function that returns to the server time-on-page metric data corresponding to an amount of time that the Web page is presented by the client;
presenting the Web page at the client;
in response to a determination to present a different Web page, evaluating the function; and
in response to evaluating the function, sending time-on-page metric data to the server.

7. The method of claim 6 further comprising:
registering the function with an event handler in the browser application; and
invoking the event handler when the browser application performs a page unload operation.

8. The method of claim 6 further comprising:
retrieving a presentation start time when the embedded script is interpreted;
retrieving a presentation end time when the function is evaluated; and
computing the time-on-page metric data as the difference between the presentation start time and the presentation end time.

9. The method of claim 6 wherein the time-on-page metric data is sent to the server as parameter data in a request message for a second Web page.

10. The method of claim 6 wherein a response for the second Web page contains a no-content or null response code.

11. An apparatus comprising:
means for generating a Web page at a server;
means for generating a script, wherein the script comprises a function that returns to the server time-on-page metric data corresponding to an amount of time that the Web page is presented by the client; and
means for inserting the script into the Web page.

12. The apparatus of claim 11 further comprising:
means for receiving from a client a request message for the Web page;
means for generating a response message, wherein the response message comprises a message body with the Web page;
means for sending the response message to the client.

13. The apparatus of claim 11 wherein a proxy server between the client and the server performs the script insertion.

14. The apparatus of claim 11 wherein the function is evaluated when a browser application at the client determines to present a different Web page other than the Web page in which the script was inserted.

15. The apparatus of claim 14 wherein the function is registered with an event handler that is invoked when the browser application performs a page unload operation.

16. An apparatus comprising:
means for sending from a client to a server a request message for a Web page;
means for receiving a response message, wherein the response message comprises a message body with the Web page;
means for interpreting the Web page, wherein the Web page has an embedded script comprising a function that returns to the server time-on-page metric data corresponding to an amount of time that the Web page is presented by the client;
means for presenting the Web page at the client;
means for evaluating the function in response to a determination to present a different Web page; and
means for sending time-on-page metric data to the server in response to evaluating the function.

17. The apparatus of claim 16 further comprising:
means for registering the function with an event handler in the browser application; and
means for invoking the event handler when the browser application performs a page unload operation.

18. The apparatus of claim 16 further comprising:
means for retrieving a presentation start time when the embedded script is interpreted;
means for retrieving a presentation end time when the function is evaluated; and
means for computing the time-on-page metric data as the difference between the presentation start time and the presentation end time.

19. The apparatus of claim 16 wherein the time-on-page metric data is sent to the server as parameter data in a request message for a second Web page.

20. The apparatus of claim 16 wherein a response for the second Web page contains a no-content or null response code.

21. A computer program product in a computer readable medium for use in a data processing system comprising:
instructions for generating a Web page at a server;
instructions for generating a script, wherein the script comprises a function that returns to the server time-on-page metric data corresponding to an amount of time that the Web page is presented by the client; and
instructions for inserting the script into the Web page.

22. The computer program product of claim 21 further comprising:
instructions for receiving from a client a request message for the Web page;
instructions for generating a response message, wherein the response message comprises a message body with the Web page;
instructions for sending the response message to the client.

23. The computer program product of claim 21 wherein a proxy server between the client and the server performs the script insertion.

24. The computer program product of claim 21 wherein the function is evaluated when a browser application at the client determines to present a different Web page other than the Web page in which the script was inserted.

25. The computer program product of claim 24 wherein the function is registered with an event handler that is invoked when the browser application performs a page unload operation.

26. A computer program product in a computer readable medium for use in a data processing system comprising:
instructions for sending from a client to a server a request message for a Web page;
instructions for receiving a response message, wherein the response message comprises a message body with the Web page;
instructions for interpreting the Web page, wherein the Web page has an embedded script comprising a function that returns to the server time-on-page metric data corresponding to an amount of time that the Web page is presented by the client;
instructions for presenting the Web page at the client;
instructions for evaluating the function in response to a determination to present a different Web page; and
instructions for sending time-on-page metric data to the server in response to evaluating the function.

27. The computer program product of claim 26 further comprising:
instructions for registering the function with an event handler in the browser application; and
instructions for invoking the event handler when the browser application performs a page unload operation.

28. The computer program product of claim 26 further comprising:
instructions for retrieving a presentation start time when the embedded script is interpreted;
instructions for retrieving a presentation end time when the function is evaluated; and
instructions for computing the time-on-page metric data as the difference between the presentation start time and the presentation end time.

29. The computer program product of claim 26 wherein the time-on-page metric data is sent to the server as parameter data in a request message for a second Web page.

30. The computer program product of claim 26 wherein a response for the second Web page contains a no-content or null response code.
